(19) United States
(12) Patent Application Publication
(10) Pub. No.: US 2017/0066501 A1
(43) Pub. Date: Mar. 9, 2017

(54) BELT-ALIGNED DERAILLEUR

(71) Applicant: Praxis Works LLC, Aptos, CA (US)

(72) Inventor: William A. Hilgenberg, Santa Cruz, CA (US)

(73) Assignee: Praxis Works LLC, Aptos, CA (US)

(21) Appl. No.: 15/207,215

(22) Filed: Jul. 11, 2016

Related U.S. Application Data
(60) Provisional application No. 62/215,411, filed on Sep. 8, 2015.

(51) Int. Cl. B62M 9/122

(52) U.S. Cl. CPC B62M 9/122

(57) ABSTRACT

A derailleur may include an electric motor configured to drive a gear assembly to pivot a rigid case around the B knuckle of the derailleur. A chain tensioner-supporting P knuckle of the derailleur may be pivotably connected to the rigid case. The P knuckle may be held substantially parallel to an associated bicycle frame by a belt that is fixed to the B knuckle shaft and passes around the P knuckle shaft. A belt tensioner may be provided between the B knuckle and P knuckle shafts.

### CROSS REFERENCES

This application claims the benefit under 35 U.S.C. §119(e) of the priority of U.S. Provisional Patent Application Ser. No. 62/215,411, filed Sep. 8, 2015, which is hereby incorporated by reference in its entirety for all purposes.

### FIELD

This disclosure relates to systems and methods for shifting gears on a bicycle or other geared vehicle. More specifically, the disclosed embodiments relate to rear derailleurs having electronic controls.

### INTRODUCTION

Rear derailleurs are used for selectively shifting a drive chain from one sprocket to another sprocket of a multi-speed freewheel or cassette comprising multiple, differently-sized sprockets. Similar structures may be applicable to a front derailleur which is used for shifting the chain from one gear to another gear of a multi-speed chain wheel comprising usually two to four differently-sized gears.

Conventional rear derailleurs generally have a parallelogram linkage mechanism for guiding the drive chain over a plurality of sprockets which are spaced axially along the axis of the rear wheel hub as disclosed, for example, in U.S. Pat. No. 3,979,962 to Kebsch; U.S. Pat. No. 4,027,542 to Nagano; and U.S. Pat. No. 4,038,878 to Dian, the entireties of which are incorporated by reference herein for all purposes.

As is well known in the art, a typical parallelogram linkage mechanism of a conventional rear derailleur is formed by four links: a stationary link, referred to as a B-knuckle, fixed to a mounting bracket (also known as a rear end plate) of a bicycle frame; a pair of biased parallel links pivotally connected at their one ends to the stationary link; and a movable link, referred to as the P-knuckle, which is opposite to the stationary link and pivotally connected to the other ends of the parallel links. The P-knuckle supports a tensioner, which includes a cage, a guide pulley, and a tension or idler pulley. The parallelogram is resiliently transformable, typically by mechanical operation of a known Bowden-type control cable, which consists of an outer tubular sheath and an inner wire passing through the sheath. The tensioner carried by the movable link can move toward and away from the bicycle frame, while always maintaining parallel relation with respect to each of a plurality of sprockets. This results in the desired effect of the chain shifting from sprocket to sprocket.

### SUMMARY

A derailleur for a bicycle may include a fixed B knuckle pivot portion; a rigid case portion pivotably mounted to the B knuckle pivot portion and housing an electric motor; a movable P knuckle pivotably connected to the case portion at a position spaced from the B knuckle pivot portion; a belt fixedly attached to a shaft of the B knuckle and looping around a shaft of the P knuckle; and a bicycle chain tensioner supported by the P knuckle. The electric motor may be operatively connected to the B knuckle pivot portion by a gear assembly, such that operation of the electric motor causes the case portion to pivot around the B knuckle. An orientation of the P knuckle may be maintained by the belt as the case portion pivots around the B knuckle.

### BRIEF DESCRIPTION OF THE DRAWINGS

FIG. 1 is an isometric view of portions of a bicycle which comprise an illustrative rear derailleur system in accordance with aspects of the present disclosure.

FIG. 2 is an isometric front view of an illustrative rear derailleur in accordance with aspects of the present disclosure.

FIG. 3 is an outboard, side elevation view of an illustrative rear derailleur in accordance with aspects of the present disclosure.

FIG. 4 is an inboard, side elevation view of the derailleur of FIG. 3.

FIG. 5 is an isometric view of an illustrative rear derailleur in a first extreme position.

FIG. 6 is an isometric view of the derailleur of FIG. 5, in a second extreme position, illustrating that the P knuckle and tensioner remain parallel to the cassette sprockets.

FIG. 7 is a bottom view of FIG. 5, with a lower case removed to show internal components.

FIG. 8 is a bottom view of FIG. 6, with a lower case removed to show internal components.

FIG. 9 is a partially transparent bottom view of an illustrative derailleur, showing relationships between internal components.

FIG. 10 is a partially transparent isometric view of the derailleur of FIG. 9.

FIG. 11 is a sectional view of the derailleur of FIG. 3, taken along a vertical plane indicated at A-A.

FIG. 12 is a sectional view of the derailleur of FIG. 3, taken along a horizontal plane indicated at D-D.

### DESCRIPTION

Overview

Various embodiments of a belt-aligned derailleur system having an electronic controller, as well as related methods, are described below and illustrated in the associated drawings. Unless otherwise specified, a derailleur system and/or its various components may, but are not required to, contain at least one of the structure, components, functionality, and/or variations described, illustrated, and/or incorporated herein. Furthermore, the process steps, structures, components, functionalities, and/or variations described, illustrated, and/or incorporated herein in connection with the present teachings may, but are not required to, be included in other similar derailleur systems. The following description of various embodiments is merely exemplary in nature and is in no way intended to limit the disclosure, its application, or uses. Additionally, the advantages provided by the embodiments, as described below, are illustrative in nature and not all embodiments provide the same advantages or the same degree of advantages.

In general, a belt-aligned derailleur system may include a rear derailleur and a derailleur controller. The rear derailleur may be motorized, such that an electric motor is used to reposition a parallelogram portion and thereby move a tensioner portion toward and away from a bicycle cassette. This motor may be controlled, either through a wired interface or a wireless communication system, by a controller or control unit accessible and manipulable by a rider of the bicycle. For example, a controller may be mounted to a handlebar of the bicycle.

The parallelogram portion of the derailleur may include an alignment system enclosed by a rigid case or combination of cases, also referred to as the parallelogram case or parallelogram assembly. Driven by the motor, the case may be rotated about a rear pivot, thereby moving a front portion (e.g., a P-knuckle) toward or away from the bicycle. The P-knuckle is pivotably mounted to the parallelogram cases. To function properly with a bicycle chain, the P-knuckle should be held parallel to the bicycle cassette sprockets. This parallelism is achieved by a continuous belt, internal to the cases, which loops around a fixed rear pivot and the rotatable front P-knuckle pivot. As the parallelogram case rotates around the rear pivot, the belt rotates the front pivot by a corresponding amount, thereby holding the P-knuckle parallel to the sprockets.

Examples, Components, and Alternatives

The following sections describe selected aspects of exemplary belt-aligned derailleur systems as well as related systems and/or methods. The examples in these sections are intended for illustration and should not be interpreted as limiting the entire scope of the present disclosure. Each section may include one or more distinct inventions, and/or contextual or related information, function, and/or structure.

System:

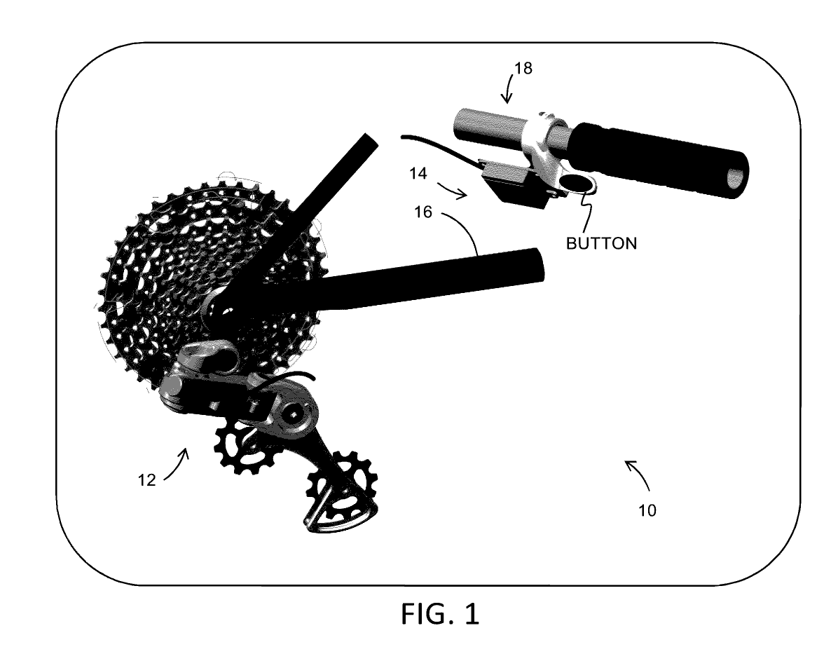

As shown in FIG. 1, this section describes a belt-aligned derailleur system 10. System 10 includes a belt-aligned derailleur 12 and a derailleur controller 14. Controller 14 may be in communication with one or more motors of derailleur 12, through a wired or wireless connection. Derailleur 12 may be securely mounted to a bicycle 16, and controller 14 may be mounted to a handlebar 18 of the bicycle.

Aspects of derailleur 12 and controller 14 (also referred to as a control unit) are described in further detail below.

Illustrative Derailleur

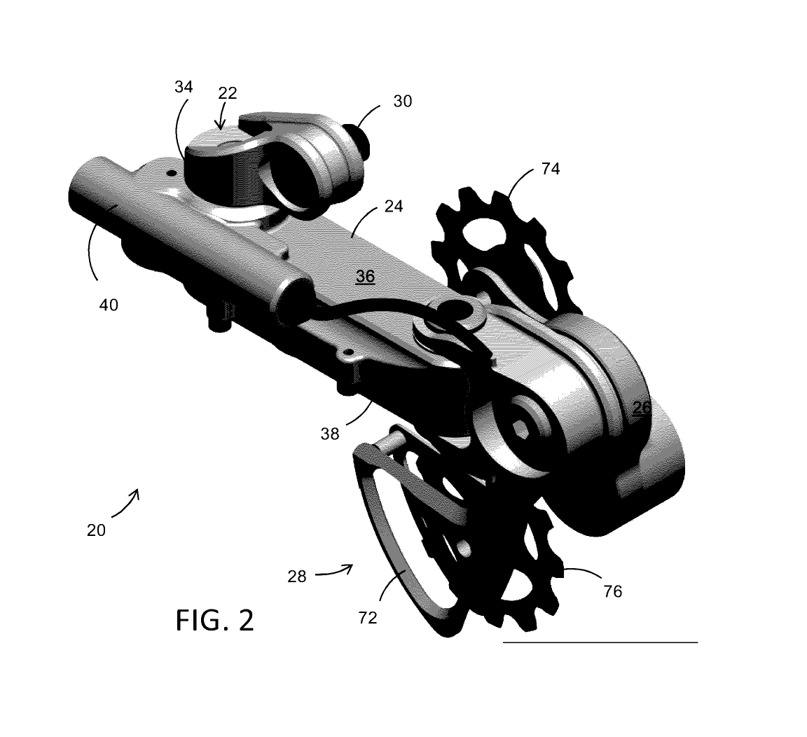

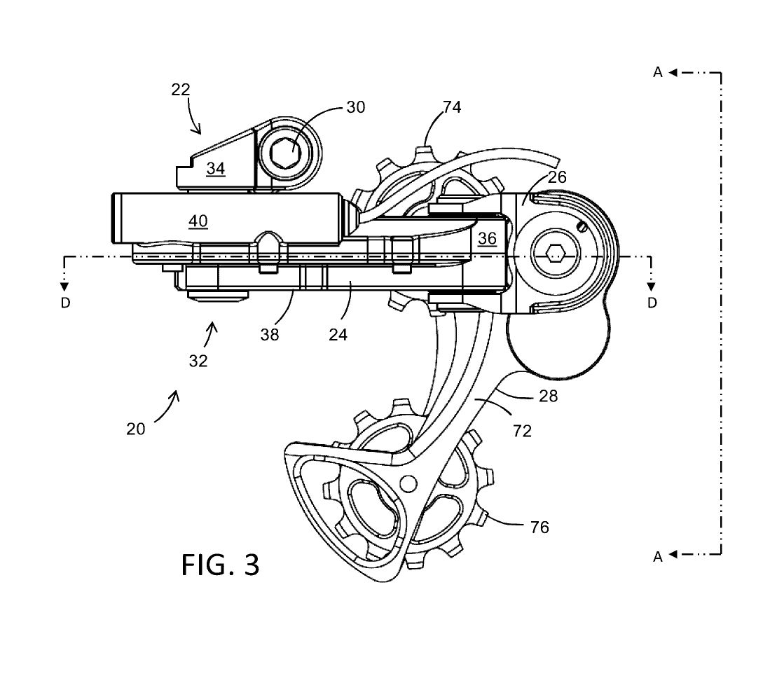

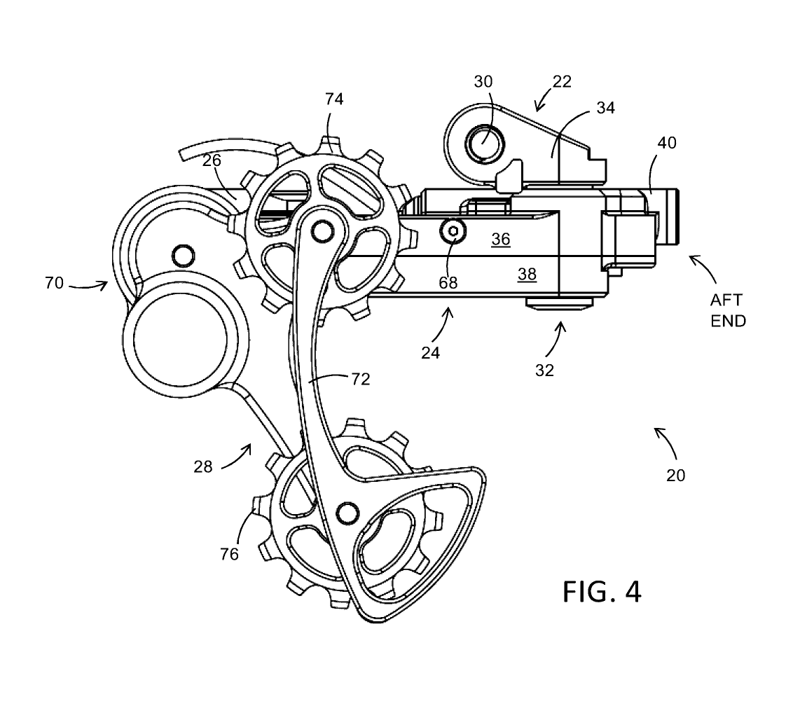

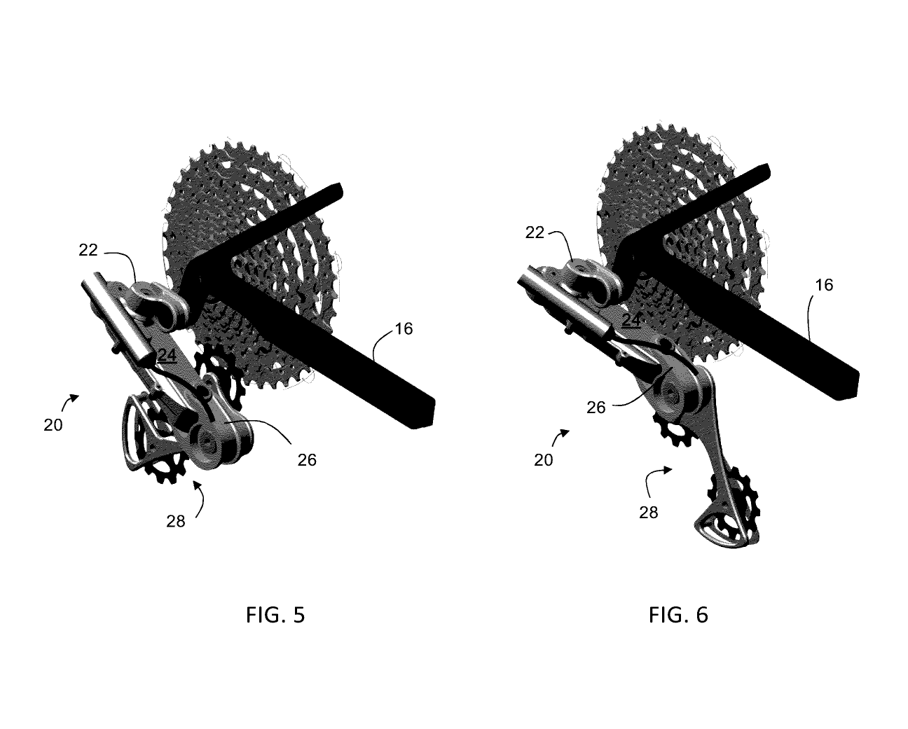

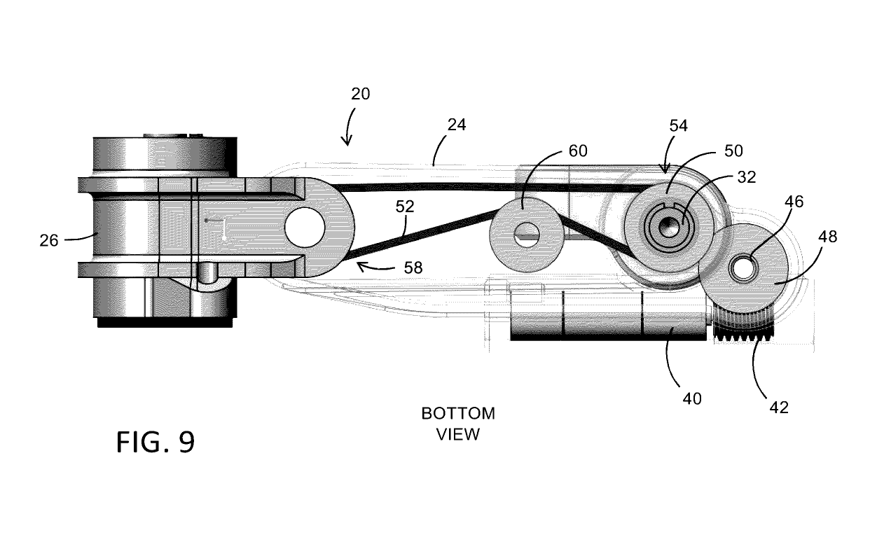

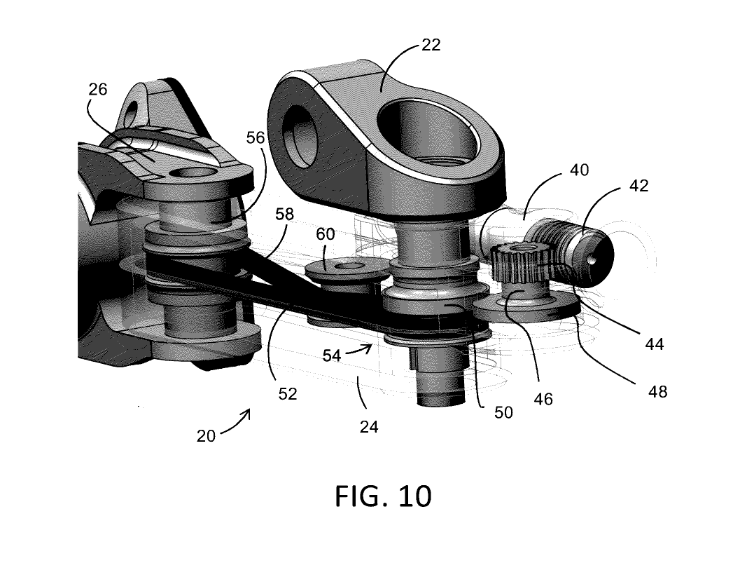

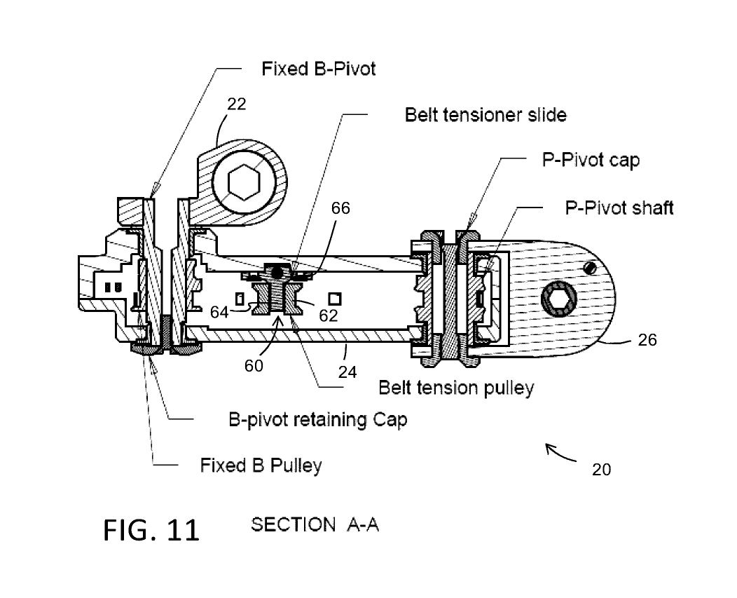

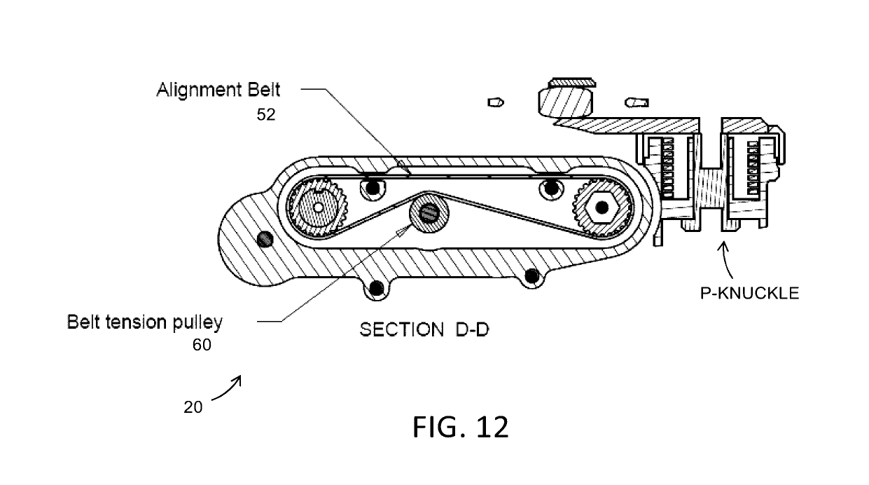

As shown in FIGS. 2-12, this section describes a belt-aligned derailleur 20 suitable for use in a belt-aligned derailleur system such as system 10. Derailleur 20 is an example of derailleur 12 described above. Accordingly, similar components may be labeled with similar reference numbers. Reference numbers are shown as needed on various drawings, with other drawings labeled using identifying words. Identities of elements shown in the remaining drawings should be clear from those that are labeled.

Belt-aligned derailleur 20 includes a fixed pivot portion 22 (also referred to as a B knuckle), a case portion 24 (also referred to as a parallelogram case or linkage case) pivotably mounted to the fixed pivot portion, a movable portion 26 (also referred to as a P knuckle), and a tensioner 28 supported by the P knuckle.

B knuckle 22 is configured to be affixed to the bicycle frame, such as by a bolt 30. A fixed pivot shaft 32 extends in a generally downward direction from a body 34 of the B knuckle. Shaft 32 is fixed, such that the shaft does not rotate, and is fixed relative to body 34.

Case portion 24 includes an upper case portion 36 and a lower case portion 38, which may be bolted together or otherwise attached to each other to form a rigid unit. Case portion 24 may include a motor 40. Motor 40 may include any suitable electrical or electronic motor controllable to move (e.g., rotate) a selected amount as instructed or otherwise directed by a controller.

A drive shaft of motor 40 may drive a worm 42 attached to the shaft. Worm 42 may in turn drive a worm gear 44 (also referred to as a pivot gear), forming a right angle drive. Worm gear 44 may share a shaft 46 with a drive gear 48. Drive gear 48 may be a different size as compared to the worm gear, such that a selected gear ratio may be achieved.

Drive gear 48 meshes with fixed gear 50 (also referred to as a secondary drive gear). Gear 50 is fixed on shaft 32 of B knuckle 22. Accordingly, rotating drive gear 48 causes gear 48 to walk around the fixed gear. Motor 40, worm 42, worm gear 44, and drive gear 48 are attached to case 24 at a first (i.e., aft) end of the case. Therefore, when gear 48 walks around the fixed gear of the B knuckle, the aft end of the case walks around the B knuckle as well, causing the case to pivot on the B knuckle shaft. This results in the opposite (front) end of the rigid case moving in an opposing direction (toward or away from the cassette sprockets). Note that drive gear 48 and fixed gear 50 are toothed, although some drawings do not show the teeth.

A belt 52 is fixed around the B knuckle shaft at a fixed belt drive pulley 54 (also referred to as a B pulley). Pulley 54 may be ribbed or otherwise textured to mate with corresponding features of the belt. P knuckle 26 is pivotably connected to the front end of case 24 by a rotatable shaft 56. Rotatable shaft 56 is rotationally coupled to P knuckle 26, such that the shaft and the movable knuckle rotate together relative to case 24. Belt 52 is looped around shaft 56, such as at a P pulley 58. A belt tensioning pulley 60 (also referred to as a belt tensioner) is mounted in case 24 on one side of the belt.

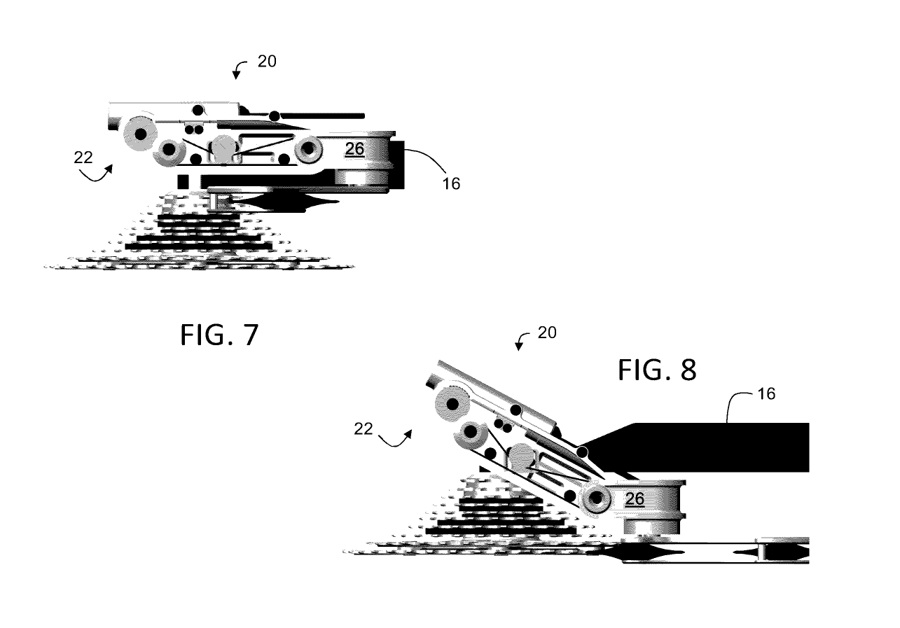

Accordingly, when the case rotates around fixed shaft 32 and the front end of the case moves toward or away from the bicycle frame, belt 52 will rotate shaft 56 in an opposite direction. For example, when viewed from below (see FIGS. 7-8), clockwise rotation of drive gear 48 causes the aft end of the case to walk away from the cassette. This results in the case pivoting around the B pivot, and the front end moves toward the cassette (see FIG. 8). Because the belt does not rotate around the B pivot, torque is applied to the rotatable P pivot shaft in a counterclockwise direction. This torque causes the P knuckle to pivot in a counterclockwise direction, thereby maintaining its parallel orientation relative to the cassette sprockets.

Belt tensioner 60 maintains tension on belt 52, and includes a pulley 62 rotatable on a shaft 64 and translatable in a slide 66. The belt tensioner is adjustable using an adjustment screw 68 (also referred to as a tensioner screw). A similar, but reversed operation occurs when the drive gear is rotated in the other direction.

Tensioner 28 is supported by P knuckle 26, such as via a biasing mechanism 70 (e.g., a spring-biased mechanism or a hydraulic clutch unit). Tensioner 28 is configured to maintain tension on a bicycle drive chain. The tensioner includes a cage 72 and two sprockets—a guide pulley 74 and a tension pulley 76 (also referred to as an idler pulley).

Operation:

This section provides another description of the operation of derailleur 20.

The B-Pivot is fixed to the B-knuckle, and the B-Knuckle is fixed to the bicycle frame. The B-Pivot pulley is fixed to the B Pivot. The P-Pivot and P-Knuckle are free to rotate. The upper case and lower case are free move as a unit. The belt is fixed to the B-pulley. This keeps the P-knuckle parallel with the B-knuckle. The belt tensioner maintains fixed belt tension.

Now turning to the stages of motion, a button or other interface element of the controller is pressed to shift the derailleur. The derailleur receives a signal to shift. Signal transmission may be wired or wireless. The motor moves specified amount, driving the worm. The worm drives the worm gear. The worm gear drives the drive gear. The drive gear runs against the B-Pivot pulley, in a toothed engagement. Resulting torque moves the cases about the B-Pivot.

The belt transmits opposing torque to the P-Pivot, to maintain parallelism of the P-Knuckle. Derailleur ceases movement after shifting over a specified distance, as dictated by the controller (also referred to as a control unit).

Illustrative Controller

An illustrative embodiment of a controller or control unit suitable for use in system 10 (e.g., controller 14) will now be described.

Aspects of the control unit may be embodied as a computer method, computer system, or computer program product. Accordingly, aspects of the control unit may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the control unit may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the control unit may be written in one or any combination of programming languages, including an object-oriented programming language such as Java, Smalltalk, C++, and/or the like, and conventional procedural programming languages, such as the C programming language. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the control unit are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Illustrative methods for shifting a derailleur and for setting up a derailleur control unit, described below, may not recite the complete process or all steps of the program. Although various steps of the methods are described below, the steps need not necessarily all be performed, and in some cases may be performed in a different order than the order shown.

In an illustrative shifting algorithm, a first step may include pushing a button or otherwise interacting with a control unit. For example, a lever may be moved, a dial may be adjusted, a touch screen may be touched, etc. Upon receiving input that the button was pushed (or other interaction), the control unit may check for a limit, e.g., that the derailleur is at a limit corresponding to a largest or smallest of the cassette sprockets. If no limit is detected, the motor may be actuated to rotate or otherwise move a selected amount. This motor actuation shifts the derailleur and chain into the desired position. That position is then recorded, and the system awaits further input.

In an illustrative setup algorithm, a setup mode may be entered, after which the center zero setting may be established, and the step size between cassette sprockets may be set. Mechanical steps may be performed in tandem, such that the derailleur is installed, the control unit is mounted, and the cassette size is determined. The control unit and/or motor may receive power from a battery or other power supply. This power supply may also be installed.

Below are examples of suitable pseudo-code for use with a derailleur control unit in accordance with aspects of the present disclosure.

Shifting Pseudocode:

```
Uplimit = int
Lowlimit= int2
Cassettenum = int3 ##read off of the pin arrangement for three-way switch
Stepsize == abs(uplimit−lowlimit)/cassettenum
For mode == 1
  if upbutton == 1
    servopin== 1 (300ms)
    if uplimit == 1
      upperlimit == position
      servopin== −1 (600ms)
    if lowlimit == 1
      lowlimit == position
      servopin== 0
For upbutton = =1
  if pos < uplimit−stepsize
    return
  else pos== pos+stepsize
For downbutton == 1
  if pos >downlimit+stepsize
    return
  else pos = pos−stepsize
```

Over-Shifting Pseudocode:

```
For upbutton = =1
    t == clock
  if pos < uplimit−stepsize
    return
  else
    while clock<=t+20 (insert required time hold here)
      pos== pos+stepsize+3
    end
    pos==pos−3
  end
```

Advantages, Features, Benefits

The different embodiments of the derailleur system described herein provide several advantages over known solutions for shifting a bicycle chain between sprockets.

For example, the illustrative embodiments of belt-aligned derailleur systems described herein allow one or more of the following advantages.

Advantages over standard derailleurs:
Fully sealed internals, therefore better in muddy conditions;
Wider bushing stance for improved stiffness;
Larger pivot size;
   Increased stiffness;
   Increased bushing life;
   Easier tolerances for manufacturing;
Fewer parts required;
   Cheaper to manufacture;
   Potentially lighter;
Two-case design allows easier servicing;
Everything can be built from the top case down, i.e., the case is the assembly fixture;
Large pivots larger overall piece size more conducive to injection molding (fewer high wear, small feature parts).

Advantages over typical electronic derailleurs:
Typical electronic derailleurs are standard parallelogram design, so see all points above;
Allows for simpler electronic component replacement (motor slides out of housing on the side);
Known electronic derailleurs rely on non-structural covers to seal electronics, whereas the disclosed embodiments can bring the electronics inside;
   Utilizes previously non-structural material as structural;
   Increases stiffness for same amount of weight.

No known system or device can perform these functions. However, not all embodiments described herein provide the same advantages or the same degree of advantage.

Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A derailleur for a bicycle, the derailleur comprising:
a fixed B knuckle pivot portion;
a rigid case portion pivotably mounted to the B knuckle pivot portion and housing an electric motor;
a movable P knuckle pivotably connected to the case portion at a position spaced from the B knuckle pivot portion;
a belt fixedly attached to a shaft of the B knuckle and looping around a shaft of the P knuckle; and
a bicycle chain tensioner supported by the P knuckle;
wherein the electric motor is operatively connected to the B knuckle pivot portion by a gear assembly, such that operation of the electric motor causes the case portion to pivot around the B knuckle; and
wherein an orientation of the P knuckle is maintained by the belt as the case portion pivots around the B knuckle.

2. The derailleur of claim 1, wherein the belt is contained within the case portion.

3. The derailleur of claim 1, wherein the belt comprises a continuous loop.

4. The derailleur of claim 1, further comprising a belt tensioner disposed between the B knuckle shaft and the P knuckle shaft.
